(19) United States
(12) Patent Application Publication
(10) Pub. No.: US 2008/0011272 A1
(43) Pub. Date: Jan. 17, 2008

(54) APPARATUS AND METHOD FOR IGNITION TIMING FOR SMALL GASOLINE ENGINE

(76) Inventors: Jorgen Bengtsson, Svanskog (SE); Gren Styrbjorn, Saffle (SE); Bert Gustafsson, Amal (SE)

Correspondence Address: NELSON MULLINS RILEY & SCARBOROUGH, LLP, 1320 MAIN STREET, 17TH FLOOR, COLUMBIA, SC, 29201, US

(21) Appl. No.: 11/776,850

(22) Filed: Jul. 12, 2007

Related U.S. Application Data
(60) Provisional application No. 60/830,298, filed on Jul. 12, 2006.

(51) Int. Cl. F02P 5/145

(52) U.S. Cl. 123/406.56; 123/406.12

(57) ABSTRACT

An apparatus and method for use with an internal combusting engine that accurately control ignition timing. Reference signals are created which are used to determine both the mean engine speed as well as irregular speed. Control logic uses this engine information to accurately predict the future rotational position of the engine. The ignition timing is then adjusted to release the spark at the appropriate time.

### PRIORITY CLAIM

This application claims the benefit of provisional application Ser. No. 60/830,298, filed Jul. 12, 2006, which is relied upon and incorporated herein by reference.

### BACKGROUND OF THE INVENTION

The present invention generally relates to an ignition timing system for small gasoline engines. More particularly, the invention relates to an apparatus and method for controlling the ignition timing by utilizing at least one reference signal per engine revolution. The at least one reference signal is preferably used to determine the mean speed of the engine as well as irregular engine speed. By controlling the ignition system by considering both mean speed and irregular speed, such as deceleration, ignition timing accuracy can be increased.

It is well known to use an analog ignition system with RPM timing control. When a magnet located on a flywheel passes a coil, a voltage spike is induced that is proportional to engine speed. This voltage spike is relative to the position of the piston and proportional to speed which allows for timing accuracy. Analog systems also will not release a spark if the RPM is below a certain amount. These types of systems, however, do not offer much flexibility when the ignition timing point is mechanically connected to the position of the pick-up coil. As such, the ignition timing will not be correct for all working conditions which can result in lower engine efficiency.

It is also well known to use control logic, such as a microprocessor, to control the ignition timing. Such systems calculate the spark position based on a reference signal and a delay time from that reference signal. Accordingly, any change in engine speed experienced after the control logic has received the reference signal but before the spark has fired will not be accounted for by the control logic. Advanced control techniques can include multiple sensors and reference signals. These control techniques increase accuracy but also increase undesired cost and add complexity to smaller engines. When determining ignition timing, timing error is often resulting from instability of the reference signal utilized by the control logic and long delay times after the reference signal has been received by the control logic to the fire command. Timing error can also result if the control logic does not take into consideration the irregularities of the engine speed.

During cranking, magneto ignitions utilizing microprocessors often use a default firing technique. Such technique does not calculate the firing of the spark based on delay time but rather uses a reference signal to directly command the spark. Default firing techniques are often used at cranking due to the high levels of irregular speed present which increases the difficulty of accurately calculating the appropriate delay. Releasing the spark at an inappropriate time during the engine's cycle can be detrimental to the engine. While default firing techniques can reduce the probability of releasing a spark at an inappropriate time, drawbacks to this type of system do exist. Specifically, the reference signal is usually delivered by a dedicated sensor which cannot then be used for other purposes. Additionally, the appropriate engine position is not supplied to the microprocessor during cranking. Thus, the microprocessor cannot perform certain beneficial functions, such as fuel control.

### SUMMARY OF THE INVENTION

The present invention recognizes and addresses the foregoing considerations, and others, of prior art construction and methods. Accordingly, it is an object of the present invention to provide an improved apparatus and method for controlling the ignition timing of an engine.

In one aspect, the present invention provides an apparatus for use with an ignition system on a small engine. The apparatus delivers reference signals to control logic. The reference signals are created by a magnet with a north and south pole located on a flywheel passing by a magnetically permeable core (lamination) with at least one leg. The at least one leg comprises at least one coil. As the magnet passes the core, positive and negative voltages are induced in the coil. Reference signals generated comprise leading and trailing edges which are dependant upon the zero crossings of the induced voltage. The amplitude of the induced voltage in the coil can be affected by a number of factors, including: RPM of the flywheel, the air-gap between the core leg and the flywheel, magnetization level of the magnet, temperature, resistance tolerance in the internal coil, internal load of the coil, and inductance. Since the technique presently disclosed uses the zero crossings of the induced voltage to create a reference signal, the varying amplitude of the induced voltage is not problematic. The zero crossings provide relatively stable angular reference points used to determine ignition timing.

In another aspect, the present invention provides a method for controlling the firing of a spark in an ignition system using at least one reference signal and control logic. The leading and trailing edges of the reference signals are used to determine the mean speed of the engine as well as determine any irregularity in the speed, such as deceleration. The control logic uses both the mean speed and the engine irregularity to determine the proper spark delay time period. A spark is released once the delay time period has lapsed.

In another aspect, the present invention provides an ignition timing technique for use during cranking. During cranking, especially with pull-started engines, there is limited opportunity to start the engine. The present invention provides an ignition timing technique which increases the likelihood of spark firing by obtaining speed information using only a portion of the first revolution. Irregularity in engine speed while cranking is also determined during the first revolution. After acquiring the speed information, the appropriate spark delay time is determined.

Accurate ignition timing is needed to facilitate increased engine performance. This timing accuracy should preferably be within about 1.5 crank angle degrees. In order to calculate the correct ignition timing point as a function of engine RPM, the engine's future rotational position needs to be predicted as a function of time. Such prediction allows for the spark to be fired at the appropriate time. The future engine position will vary with engine RPM and the level of irregularity of engine speed. The level of irregularity of engine speed will vary according to RPM, engine load, engine acceleration or deceleration, engine inertia, and other external and internal factors.

The accompanying drawings, which are incorporated in and constitute a part of this specification, illustrate one or more embodiments of the invention and, together with the description, serve to explain the principles of the invention.

### DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a diagrammatic elevational view showing various components in a discharge ignition system;

FIG. 2 is a plot of induced voltage in the coil versus time;

FIG. 3 is a graphical representation of the sequence of a 4-stroke engine cycle; and

FIG. 4 is a block diagram of an apparatus constructed in accordance with an embodiment of the present invention.

Repeat use of reference characters in the present specification and drawings is intended to represent same or analogous features or elements of the invention.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations.

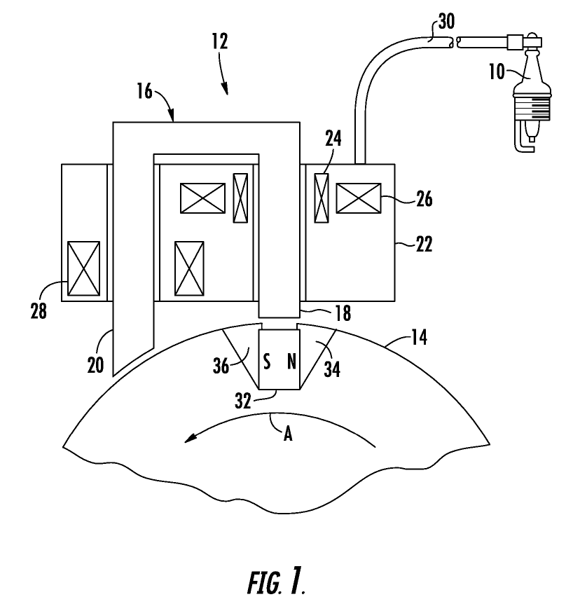

FIG. 1 illustrates a discharge ignition apparatus that may be used with various devices powered by gasoline engines. The apparatus is configured to produce the requisite spark at spark plug 10 to ignite the air-fuel mixture within the piston cylinder of the engine. Generally, the apparatus includes a stator unit 12 and a rotatable flywheel 14. Flywheel 14 typically includes a central bore for mounting to a rotatable spindle mechanism interconnected with the engine's drive shaft. As a result, rotation of the spindle will produce a concomitant rotation of flywheel 14 (such as in the direction indicated by arrow A).

Stator unit 12, which typically remains fixed with respect to the engine during use, includes a magnetically permeable core 16. In this case, core 16 includes two depending leg portions, respectively indicated at 18 and 20. In many embodiments, however, the magnetically permeable core may be constructed having three such leg portions.

A sealed housing 22 maintains the various coils and other components utilized to produce a spark at spark plug 10. In particular, housing 22 includes a high voltage transformer having a primary coil 24 and a secondary coil 26. In the illustrated embodiment, coils 24 and 26 may be mounted coaxially about leg portion 18. A charge coil 28 provides a source of energy for the ignition spark. In this case, charge coil 28 is mounted about leg portion 20 as shown.

The various coils and circuit components located within housing 22 may be protected and maintained securely in position by a suitable potting compound. Electrical connection with spark plug 10 is achieved by a typical interconnecting wire 30.

A magnet assembly is mounted adjacent the periphery of flywheel 14 to revolve about a circular path in synchronism with operation of the engine. The magnet assembly includes a permanent magnet 32 having pole pieces 34 and 36 mounted at respective ends thereof. It will be appreciated that the circumferential faces of pole pieces 34 and 36 will pass proximate to the end faces of leg portions 18 and 20 as flywheel 14 is rotated. Rotation of flywheel 14 thus produces a time-varying magnetic flux within core 16 as desired.

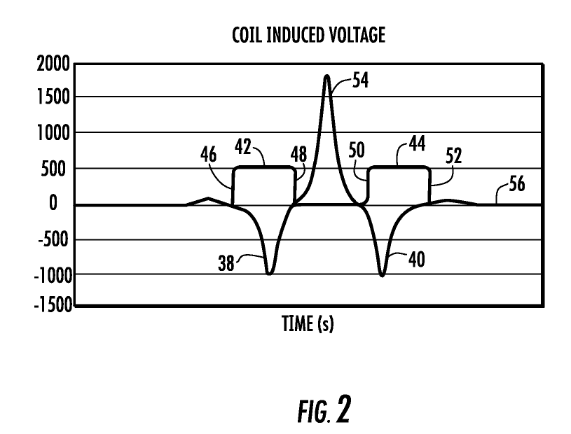

Referring to FIG. 2, an induced voltage 54 present in a coil, such as charge coil 28, is shown as a function of time. As the permanent magnet 32 approaches the core leg, a first negative voltage pulse 38 is induced in the coil by the magnetic field. Following first negative voltage pulse 38, a positive voltage pulse 54 is induced in the coil. Finally, as the magnet passes the core, a second negative voltage pulse 40 is induced in the coil. Instead of using a magneto system with a coil, any other acceptable voltage inducing method can be used. In a capacitive discharge (CD) ignition system, positive induced voltage pulse 54 serves to charge a capacitor that is used to deliver energy to the ignition circuit.

First negative voltage pulse 38 and second negative voltage pulse 40 induced in the system by passage of the magnet are used to create a first reference signal 42 and a second reference signal 44. First and second reference signals 42, 44 are utilized by the control logic as reference signals for ignition timing purposes. It should be noted that the invention is not limited for use with negative induced voltage; the induced voltage can be inverted. Edge one 46, which is the leading edge of first reference signal 42, is created by the first zero crossing of induced voltage 56. Edge two 48, which is the trailing edge of first reference signal 42, is created at the second zero crossing, which occurs when induced voltage 56 becomes positive. Following positive voltage pulse 54 is edge three 50, which is the leading edge of second reference signal 44 and is created by the third zero crossing of induced voltage 56. Edge four 52, which is the trailing edge of the second reference signal 44, is created at a fourth zero crossing, which is when induced voltage 56 becomes positive. In the preferred embodiment, the spacing between edge one 46 and edge two 48 is approximately 15 crank angle degrees. The spacing between edge three 50 and edge four 52 is also approximately 15 crank angle degrees. In certain embodiments where some signal-to-noise ratio is required, the reference signal edges may be established when the voltage is the closest to zero.

First and second reference signals 42, 44 are received and analyzed by the control logic and used to determine the ignition timing. The edges of the reference signals produced are generally not affected by external conditions of the engine. Accordingly, the leading and trailing edges of the signals occur at the same angular position each cycle thereby providing stable reference points. (As understood by one skilled in the art, time delaying components of the charge circuit, such as capacitance and inductance, may serve to delay edge three 50.) The present invention preferably uses these four edges to determine mean engine speed and irregular engine speed in different ways for different engine working conditions. Using this information, the future engine position is predicted and the timing point of the ignition firing can be adjusted accordingly.

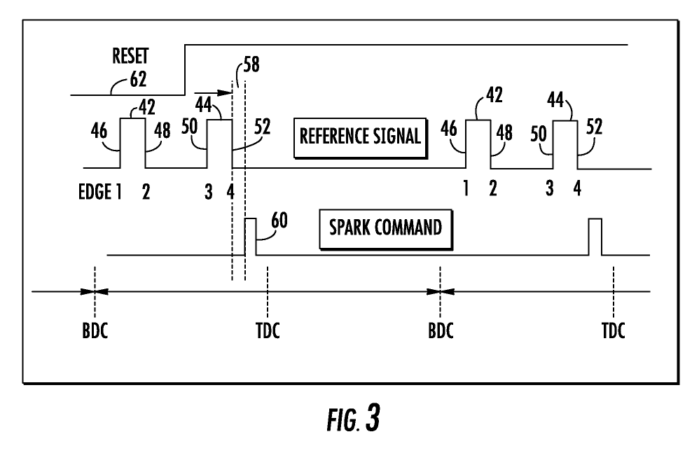

Referring now to FIG. 3, first and second reference signals 42, 44 are shown as a function of time. As described above, edge one 46 is unaffected by internal loads, and edge four 52 is largely unaffected by internal loads. In one embodiment, edge four 52 is positioned at 40 degrees before top dead center (BTDC). This position is preferred since in a typical magneto ignition system the time period between edge two 48 and edge three 50 is used to charge the voltage storage device, such as a capacitor. Positioning edge four 52 at 40 degrees BTDC allows for both the charging to occur and for a spark delay time 58 to be calculated by the control logic. For instance, if the engine timing point for maximum power is determined to be at 35 degrees BTDC, the charging and calculations have to be performed before the engine reaches 35 degrees BTDC. It will be understood by those skilled in the art that this calculation time will depend upon the control logic capability.

The mean speed can be determined by measuring the time between edge one 46 during a first revolution and the occurrence of the edge one 46 during a subsequent revolution. Measuring the time between occurrences of other edges during revolutions can also be used to determine mean speed. The time between edge one 46 and edge four 52 may be used by the control logic to determine irregular engine speed. If the irregular engine speed is calculated to be faster or slower than the mean speed, spark delay time 58 may be adjusted accordingly.

For a four-cycle engine, the mean speed can be calculated by using a complete four stroke cycle of 720 degrees adjusted with a piston deceleration factor that will vary based upon load and other external factors. To calculate this deceleration factor, the actual speed of the engine is preferably determined at the point nearest to the firing of the spark. Thus, the time is measured between any two reference signals preferably during the compression stroke.

During cranking, the necessity for accurately determining engine speed in order to establish ignition timing is great. Once spark delay time 58 has been established, a spark will be released when that delay time has been reached. Thus, once spark delay time 58 has been established, any change in engine speed will not be considered before the spark is released. If the spark is released when the piston's velocity is too low, the combustion may force the piston backward (commonly called “kick back”) and damage parts of the engine. The present invention considers not only engine speed when calculating delay time, but also preferably considers the deceleration of the engine. Using this information, the control logic is able to predict if the piston's velocity will be sufficient at the time the spark would be released thereby reducing the chances of kick back.

During each pull of a large pull-started four stroke engine, the engine usually only has two complete engine cycles to start. Thus, each pull yields only two compression strokes and two corresponding attempts to start the engine. As is well known in the art, ignition systems often use the first complete engine cycle to receive timing information. These systems then proceed to fire the spark, if possible, during the subsequent complete engine cycle. Therefore, since a spark is not released during the first cycle, the opportunity to start the engine is greatly reduced.

The present invention provides alternate techniques for calculating the engine speed which increase the opportunity to start the engine during cranking. Referring again to FIG. 3, a voltage reset signal 62 is generated by a voltage sensor which monitors the positive induced voltage in the coil. After receiving reset signal 62, the next two signals received by the control logic are always edge three 50 and edge four 52. Thus, during a portion of the first revolution during cranking, the RPM and irregular speed is determined by analyzing the time between reset 62, edge three 50, and edge four 52. Such calculation is performed if three time marks are available making it possible to calculate the trend of the RPM. If only two reference positions exist then static RPM can be calculated. This measured speed and rate of speed change is then compared to a threshold speed and rate of speed change by the control logic. If the measured speed exceeds the threshold speed and the rate of speed change is within predetermined limits then the piston has the proper velocity to overcome top dead center and the spark will be released at the calculated delay time via spark command 60. If the measured speed does not exceed the threshold speed, and if the rate of speed change is not within the predetermined limits, then the control logic will not release a spark.

During the next turn the control logic will receive signals from all four edges. At that point, the RPM can be calculated over a 360 degree revolution based on next time the signal from edge three 50 is received by the control logic. The irregular speed information can be determined by analyzing the delay between edge three 50 and edge four 52 and spark delay time 58 can be adjusted accordingly. During the next cycle, the control logic preferably switches to edge one 46 to establish mean speed and the time between edge one 46 and edge four 52 to determine irregular speed information. It should be noted that due to the time delaying components of the charge circuit, edge three 46 is preferably only used for measurement during low periods of low RPM since edge three 46 may become slightly time shifted during periods of high RPM due to capacitances and inductances present in the ignition circuit.

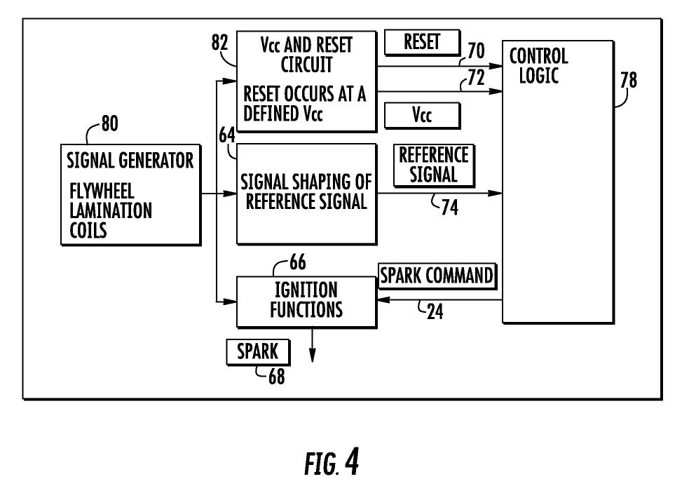

A block diagram as shown in FIG. 4 represents a preferred embodiment of the present invention. The flywheel in combination with the magnetically permeable core (lamination) and coil functions as a signal generator 80 to create voltage pulses. Various circuitry is the utilized to produce a variable spark time delay. In this case, for example, the pulses are delivered to a Vcc and reset circuit 82, a signal shaping circuit 64, and an ignition circuit 66. Vcc and reset circuit 82 delivers reset signal 70 and Vcc signal 72 to control logic 78. Signal shaping circuit 64 delivers reference signal 74 to control logic 78. Control logic 78 determines spark delay time 58 and delivers spark command 60 to ignition circuit 66 which releases spark 68. One skilled in the art will recognize that the circuitry may comprise hardware, processors or other devices implementing software or firmware, as well as various combinations of the foregoing.

The following are algorithms that can be used to calculate the “Spark Delay Time” (ΔT). The Spark Delay Time is the time period between the receiving of the reference signal and the release of the spark.

$$Δ T = \frac{{α}_{Should} - {α}_{16}}{{α}_{16 - 10}} ⨯ {T}_{{( 16 - 10 )}_{n}} [ 1 + c ( {T}_{( 16 - 10 ) n} - {T}_{( 16 - 10 ) n - 1} ) ] \qquad Eq . 1$$

Where:
ΔT=Calculated spark delay time from edge four 52.
α_{Should}=Ignition timing value in degrees before top dead center based on the mean speed for one engine cycle (720 degrees). This value is preferably stored in a look up table.
α₁₆=Angle position for edge four 52 based on actual engine cycle revolution (720 degrees for a 4-stroke engine). This value is preferably stored in a look up table. This angle position variable compensates for shifts in the position of edge four 52 due to RPM change in combination with internal frequency dependent components in the circuit.
α₁₆₋₁₀=The angle between edge one 46 to edge four 52 for the actual engine revolution based on 360 degrees. This value is preferably stored in a look up table.
T₍₁₆₋₁₀₎ₙ=The angle between edge one 46 to edge four 52 for the ongoing revolution.
T₍₁₆₋₁₀₎ₙ₋₁=The angle between edge one 46 to edge four 52 for the previous engine revolution.
c=A constant that is based on 360 or 720 degrees of information and is to compensate for irregular speed.

This above described algorithm does not require many computational resources since the calculations do not involve division. The following algorithms are preferred for low inertia applications and require more computational resources.

$$\begin{matrix}Δ T = \frac{{α}_{Should} - {α}_{16}}{{ω}_{( 16 - 10 )} + ( {ω}_{( 16 - 10 )} - {ω}_{( 10 - 16 )} ) ⨯ \frac{{α}_{Should} - {α}_{16}}{{α}_{( 16 - 10 )}} ⨯ c} & Eq . 2 \\ Δ T = \frac{{α}_{( 16 - 10 )}}{{ω}_{( 16 - 10 )}} ⨯ \frac{1}{c + \frac{{α}_{( 16 - 10 )}}{{α}_{Should} - {α}_{16}} - c \frac{{ω}_{( 10 - 16 )}}{{ω}_{( 16 - 10 )}}} & Eq . 3\end{matrix}$$

Where:
ΔT=Calculated spark delay time from edge four 52.
α_{Should}=Ignition timing value in degrees before top dead center based on the mean speed for one engine cycle (720 degrees). This value is preferably stored in a look up table.
α₁₆=Angle position for edge four 52 based on actual engine cycle revolution (720 degrees for a 4-stroke engine). This value is preferably stored in a look up table. This angle position variable compensates for shifts in the position of edge four 52 due to RPM change in combination with internal frequency dependent components in the circuit
α₍₁₆₋₁₀₎=The angle between edge one 46 to edge four 52 for the actual engine revolution based on 360 degrees. This value is preferably stored in a look up table.
ω₍₁₆₋₁₀₎=Angular speed from edge one 46 to edge four 52.
ω₍₁₀₋₁₆₎=Angular speed from edge four 46 to edge four 52.
c=A constant that is based on 360 or 720 degrees of information and is to compensate for irregular speed.

$$Δ T = \frac{{T}_{( 16 - 10 )}}{c + \frac{{α}_{( 16 - 10 )}}{{α}_{Should} - {α}_{16}} - c \frac{ {α}_{( 10 - 16 )} ⨯ {T}_{( 16 - 10 )}}{{α}_{( 16 - 10 )} ⨯ {T}_{( 10 - 16 )}}} \qquad Eq . 4$$

Where:
ΔT=Calculated spark delay time from edge four 52.
α_{Should}=Ignition timing value in degrees before top dead center based on the mean speed for one engine cycle (720 degrees). This value is preferably stored in a look up table.
α₁₆=Angle position for edge four 52 based on actual engine cycle revolution (720 degrees for a 4-stroke engine). This value is preferably stored in a look up table. This angle position variable compensates for shifts in the position of edge four 52 due to RPM change in combination with internal frequency dependent components in the circuit
α₍₁₆₋₁₀₎=The angle between edge one 46 to edge four 52 for the actual engine revolution based on 360 degrees. This value is preferably stored in a look up table.
α₍₁₀₋₁₆₎=360−α₍₁₆₋₁₀₎.
T₍₁₆₋₁₀₎=Time from edge one 46 to edge four 52.
T₍₁₀₋₁₆₎=Time from edge four 46 to edge four 52. This time period is equivalent to the time for one full 360 degrees rotation minus T₍₁₆₋₁₀₎.
c=A constant that is based on 360 or 720 degrees of information and is to compensate for irregular speed.

$$Δ T = \frac{{T}_{( 16 - 10 )}}{c + \frac{{α}_{( 16 - 10 )}}{{α}_{Should} - {α}_{16}} - c ( \frac{360}{{α}_{( 16 - 10 )}} - 1 ) ⨯ \frac{{T}_{( 16 - 10 )}}{{T}_{( 10 - 16 )}}} \qquad Eq . 5$$

Where:
ΔT=Calculated spark delay time from edge four 52.
α_{Should}=Ignition timing value in degrees before top dead center based on the mean speed for one engine cycle (720 degrees). This value is preferably stored in a look up table.
α₁₆=Angle position for edge four 52 based on actual engine cycle revolution (720 degrees for a 4-stroke engine). This value is preferably stored in a look up table. This angle position variable compensates for shifts in the position of edge four 52 due to RPM change in combination with internal frequency dependent components in the circuit
α₍₁₆₋₁₀₎=The angle between edge one 46 to edge four 52 for the actual engine revolution based on 360 degrees. This value is preferably stored in a look up table.
T₍₁₆₋₁₀₎=Time from edge one 46 to edge four 52.
T₍₁₀₋₁₆₎=Time from edge four 52 to edge one 46. This time period is equivalent to the time for one full 360 degrees rotation minus T₍₁₆₋₁₀₎.
c=A constant that is based on 360 or 720 degrees of information and is to compensate for irregular speed.

It should be clear that the above described algorithms will work as long as the system has information regarding the edges. Therefore, the algorithms are not limited for use with edges 46 and 52.

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made.

What is claimed is:

1. An ignition timing system comprising:
circuitry including control logic;
a movable magnet;
a coil mounted such that movement of said movable magnet generates a voltage in said coil, said voltage crossing a voltage threshold at least two times during movement of said movable magnet;
a first reference signal generated by said circuitry, said first reference signal having a leading edge corresponding to a first threshold crossing and a trailing edge corresponding to a second threshold crossing; and
said reference signal being utilized by said control logic to determine a variable spark time delay.

2. An ignition timing system as set forth in claim 1, wherein said moveable magnet is mounted on a flywheel.

3. An ignition timing system as set forth in claim 2, wherein a mean engine speed is determined based on a time differential between said leading edge of said first reference signal during at least two revolutions of said flywheel.

4. An ignition timing system as set forth in claim 3, wherein said mean engine speed is utilized in determining said spark time delay.

5. An ignition timing system as set forth in claim 2, wherein a mean engine speed is determined based on the time differential between said trailing edge of said first reference signal during at least two revolutions of said flywheel.

6. An ignition timing system as set forth in claim 5, wherein a spark time delay is determined by analyzing said mean engine speed.

7. An ignition timing system as set forth in claim 4, wherein said voltage crosses said voltage threshold at least four times during a rotation of said flywheel.

8. An ignition timing system as set forth in claim 7, wherein a second reference signal is generated by said circuitry having a leading edge corresponding to a third zero crossing and a trailing edge corresponding to a fourth zero crossing.

9. An ignition timing system as set forth in claim 8, wherein irregular engine speed is determined based on the time differential between said leading edge of said first reference signal and said trailing edge of said second reference signal.

10. An ignition timing system as set forth in claim 9, wherein said spark time delay is determined by analyzing said mean engine speed and irregular engine speed.

11. An ignition timing system comprising:
circuitry including control logic;
a movable magnet mounted on a flywheel;
a coil mounted such that movement of said movable magnet generates a voltage in said coil, said voltage crossing a voltage threshold at least four times during movement of said movable magnet;
a first reference signal generated by said control logic circuitry, said first reference signal having a leading edge corresponding to a first zero crossing and a trailing edge corresponding to a second zero crossing;
a second reference signal generated by said control logic circuitry, said second reference signal having a leading edge corresponding to a third zero crossing and a trailing edge corresponding to a fourth zero crossing;
a reset signal generated by said circuitry during cranking; and
said circuitry utilizing at least two of said first reference signal, said second reference signal and said reset signal to determine a variable spark time delay.

12. An ignition timing system as set forth in claim 11, wherein a mean engine speed is determined based on a time differential between said leading edge of said first reference signal during at least two revolutions of said flywheel.

13. An ignition timing system as set forth in claim 12, wherein said spark time delay is determined by analyzing said mean engine speed.

14. An ignition timing system as set forth in claim 11, wherein a mean engine speed is determined based on the time differential between said trailing edge of said first reference signal during at least two revolutions of said flywheel.

15. An ignition timing system as set forth in claim 14, wherein a spark time delay is determined by analyzing said mean engine speed.

16. An ignition timing system as set forth in claim 11, wherein irregular engine speed is determined based on the time differential between said leading edge of said first reference signal and said trailing edge of said second reference signal.

17. An ignition timing system as set forth in claim 16, wherein said spark time delay is determined based on said mean engine speed and irregular engine speed.

18. An ignition timing system as set forth in claim 17, wherein said reset signal is generated by said circuitry in response to a positive voltage in said coil.

19. An ignition timing system as set forth in claim 11, wherein irregular engine speed is determined based on the time differential between said reset signal, leading edge of said second reference signal, and said trailing edge of said second reference signal.

20. An ignition timing system as set forth in claim 19, wherein mean engine speed is determined based on the time differential between said leading edge of said second reference signal and said trailing edge of said second reference signal.

21. An ignition timing system as set forth in claim 20, wherein a spark is released if said mean engine speed and said irregular speed are within predetermined limits.

22. A method for controlling an ignition timing system, said method comprising steps of:
(a) generating a voltage in a coil with a magnet mounted on a rotating flywheel;
(b) detecting a first threshold crossing and a second threshold crossing of said voltage;
(c) generating a first reference signal with a leading edge corresponding to said first threshold crossing and a trailing edge corresponding to said second threshold crossing;
(d) detecting a third threshold crossing and a fourth threshold crossing of said voltage;
(e) generating a second reference signal with a leading edge corresponding to said third threshold crossing and a trailing edge corresponding to said fourth threshold crossing; and
(f) determining a variable spark time delay based on said first reference signal and said second reference signal.

23. A method as set forth in claim 22, wherein a mean engine speed is determined based on the time differential between the leading edge of the first reference signal during at least two revolutions.

24. A method as set forth in claim 23, wherein an irregular engine speed is determined based on the time differential between the leading edge of the first reference signal and the trailing edge of the second reference signal.

25. A method as set forth in claim 24, wherein said spark delay time is calculated based on said main engine speed and said irregular engine speed.

26. A method as set forth in claim 22, wherein a mean engine speed is determined based on the time differential between the trailing edge of the first reference signal during at least two revolutions.

27. A method as set forth in claim 22, wherein a mean engine speed is determined based on the time differential between the leading edge of the second reference signal during at least two revolutions.

28. A method for determining speed of an internal combustion engine, said method comprising steps of:
(a) generating a voltage in a coil with a magnet mounted on a rotating flywheel;
(b) detecting a first threshold crossing and a second threshold crossing of said voltage;
(c) generating a first reference signal with a leading edge corresponding to said first threshold crossing and a trailing edge corresponding to said second threshold crossing;
(d) detecting a third threshold crossing and a fourth threshold crossing of said voltage;
(e) generating a second reference signal with a leading edge corresponding to said third threshold crossing and a trailing edge corresponding to said fourth threshold crossing; and
(f) determining engine speed based on at least one of said reference signals.

29. A method as set forth in claim 28, wherein a mean engine speed is determined based on the time differential between the leading edge of the first reference signal during at least two revolutions.

30. A method as set forth in claim 28, wherein an irregular engine speed is determined based on the time differential between the leading edge of the first reference signal and the trailing edge of the second reference signal.

31. A method as set forth in claim 28, wherein a mean engine speed is determined based on the time differential between the trailing edge of the first reference signal during at least two revolutions.

32. A method as set forth in claim 28, wherein a mean engine speed is determined based on the time differential between the leading edge of the second reference signal during at least two revolutions.

33. A method as set forth in claim 28, wherein a mean engine speed is determined based on the time differential between the trailing edge of the second reference signal during at least two revolutions.
